(19) United States
(12) Patent Application Publication
(10) Pub. No.: US 2010/0212972 A1
(43) Pub. Date: Aug. 26, 2010

(54) VEHICLE FOR WEIGHING AN ITEM

(75) Inventor: Bill Hartman, Victoria (AU)

Correspondence Address: PARK, VAUGHAN & FLEMING LLP, 2820 FIFTH STREET, DAVIS, CA, 95618-7759, US

(73) Assignee: MIRRAVIEW PTY LTD, Tottenham, Victoria (AU)

(21) Appl. No.: 12/670,380

(22) PCT Filed: Jul. 24, 2008
(86) PCT No.: PCT/AU2008/001075

§ 371 Date: May 4, 2010

(30) Foreign Application Priority Data
Jul. 25, 2007 (AU) 2007904000

(51) Int. Cl. G01G 19/08

(52) U.S. Cl. 177/1; 177/136

(57) ABSTRACT

A vehicle for weighing an item, including a chassis having a plurality of wheels for effecting movement of the vehicle across a floor or ground surface; weighing apparatus for bearing weight of the item and generating data representing the weight of the item; and indicator apparatus for receiving said data representing the weight of the item and generating an indicator for the weight of the item.

### TECHNICAL FIELD OF THE INVENTION

The present invention relates to a vehicle for weighing an item. The present invention also relates to a weighing apparatus for a forklift. The present invention also relates to a method of weighing an item.

### BACKGROUND OF THE INVENTION

Forklifts, and other similar vehicles, have previously been used in warehouses to pick up, move, and set down crates of goods, for example. Forklifts can be used to lift crates and stack them on elevated shelves. It may be the case that shelving in a warehouse, for example, is rated to store items having of a combined weight below a predetermined limit. With such shelving, it may be necessary to weigh items before they are placed on the shelf. It may be difficult and/or generally inconvenient to transport each item to a weighing device before it can be placed on a shelf.

Forklifts, and other lifting devices, have previously been used to stack items, such as crates, on trucks for transportation to distant locations. For safety reasons, amongst other things, trucks typically have a weight limit to which they must legally abide. A truck driver will likely receive a penalty, in the form of a fine, if the relevant authorities determine that the load on the truck has exceeded its limit when the truck is in transit. It is therefore important during loading to accurately keep track of the weight of the items being loaded to ensure that their cumulative weight does not exceed the truck's weight limit. It may be difficult and/or time consuming to accurately measure the weight of each item before it is stacked on the truck.

It is generally desirable to overcome or ameliorate one or more of the above mentioned difficulties, or at least provide a useful alternative.

### SUMMARY OF THE INVENTION

In accordance with one aspect of the present invention, there is provided a vehicle for weighing an item, including:

(a) a chassis having a plurality of wheels for effecting movement of the vehicle across a floor or ground surface;

(b) weighing apparatus for bearing weight of the item and generating data representing the weight of the item; and

(c) indicator apparatus for receiving said data representing the weight of the item and generating an indicator for the weight of the item.

In accordance with another aspect of the present invention, there is provided weighing apparatus for a forklift, including:

(a) first and second scales couplable to respective ones of prongs of the forklift, said scales adapted to bear weight of an item therebetween and generate data representing the weight of the item; and

(b) indicator apparatus for receiving said data representing the weight of the item and generating an indicator for the weight of the item.

In accordance with another aspect of the invention, there is provided a method of weighing an item using the above described vehicle, including the steps of:

(a) arranging the item on the weighing apparatus of the vehicle; and

(b) observing the indicator.

In accordance with another aspect of the invention, there is provided a method of weighing an item using the above described vehicle, including the steps of

(a) arranging the item on the weighing apparatus of the vehicle under the item;

(b) engaging the driving apparatus to effect substantially normal movement of the load bearing platform with respect to the ground or floor surface; and

(c) observing the indicator.

### BRIEF DESCRIPTION OF THE DRAWINGS

Preferred embodiments of the present invention are hereafter described, by way of non-limiting example only, with reference to the accompanying drawing in which:

FIG. 1 is a diagrammatic illustration of a side view of a vehicle in accordance with a preferred embodiment of the invention;

FIG. 2 is a diagrammatic illustration of a top view of the vehicle shown in FIG. 1;

FIG. 3 is a diagrammatic illustration of a side view of a vehicle in accordance with a preferred embodiment of the invention;

FIG. 4 is a diagrammatic illustration of a top view of the vehicle shown in FIG. 3;

FIG. 5 is a diagrammatic illustration of a side view of a scale of the vehicle shown in FIG. 3;

FIG. 6 is a diagrammatic illustration of a top view of the scale shown in FIG. 5;

FIG. 7 is a diagrammatic illustration of an end view of the scale shown in FIG. 5;

FIG. 8 is a diagrammatic illustration of the scale shown in FIG. 5 arranged in another condition of use;

FIG. 9 is a circuit diagram of the electric components of the scale shown in FIG. 5; and

FIG. 10 is a diagram of the weighing apparatus of the vehicle shown in FIG. 3.

### DETAILED DESCRIPTION OF PREFERRED EMBODIMENTS OF THE INVENTION

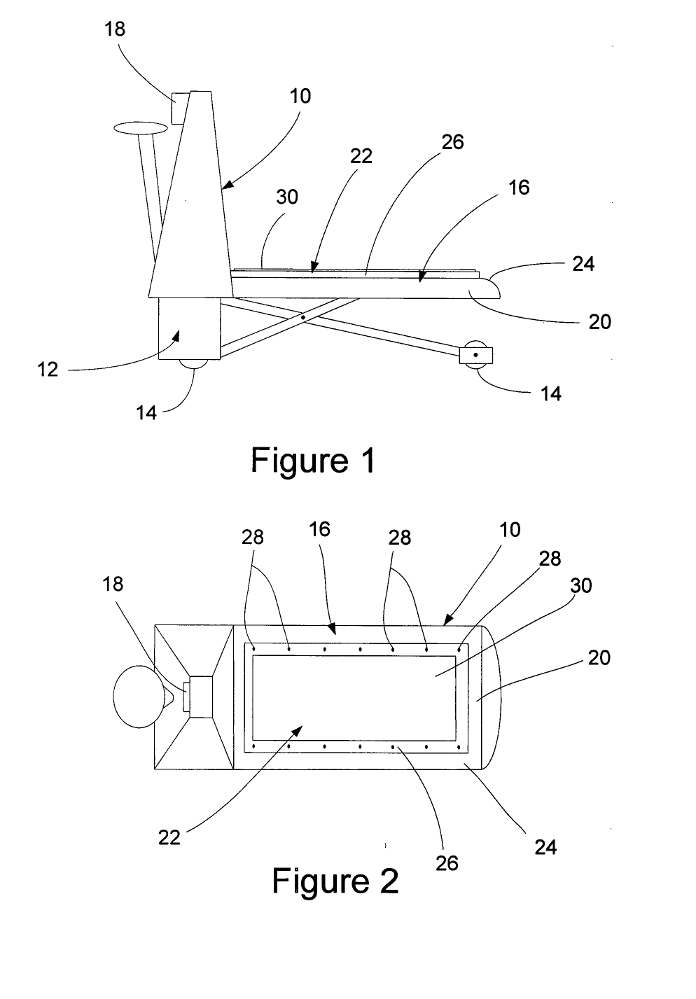

The vehicle 10 shown in FIGS. 1 and 2 can be used to weigh an item, such as a crate of boxes, and to transport the item around the floor space of a warehouse, for example. The vehicle 10 can also preferably be used to elevate the item above the floor space of the warehouse so that it can be loaded onto a truck or a shelf. The vehicle 10 is preferably a forklift, for example.

The vehicle 10 includes a chassis 12 having a plurality of wheels 14 for effecting movement of the vehicle 10 across a floor or ground surface. The vehicle 10 also includes weighing apparatus 16 for bearing weight of the item and generating data representing the weight of the item. The vehicle 10 also includes indicator apparatus 18 for receiving the data representing the weight of the item and generating an indicator for the weight of the item. The indicator is data representing the weight for display on a visual display device (not shown). Alternatively, the indicator is data representing the weight for a printing device (not shown) that prints the weight on a docket.

The weighing apparatus 16 includes a generally planar load bearing platform 20 capable of supporting the weight of the item. A scale 22 is coupled to an upper side 24 of the load bearing platform 20. The scale includes a stator 26 coupled to the load bearing platform 20 by way of fasteners 28; a movable platform 30; and a plurality of load cells (not shown) arranged between the stator 26 and the movable platform 30. The load cells generate the data representing the weight of the item seated on the scale 22. The indicator apparatus 18 receives this data and generates the indicator.

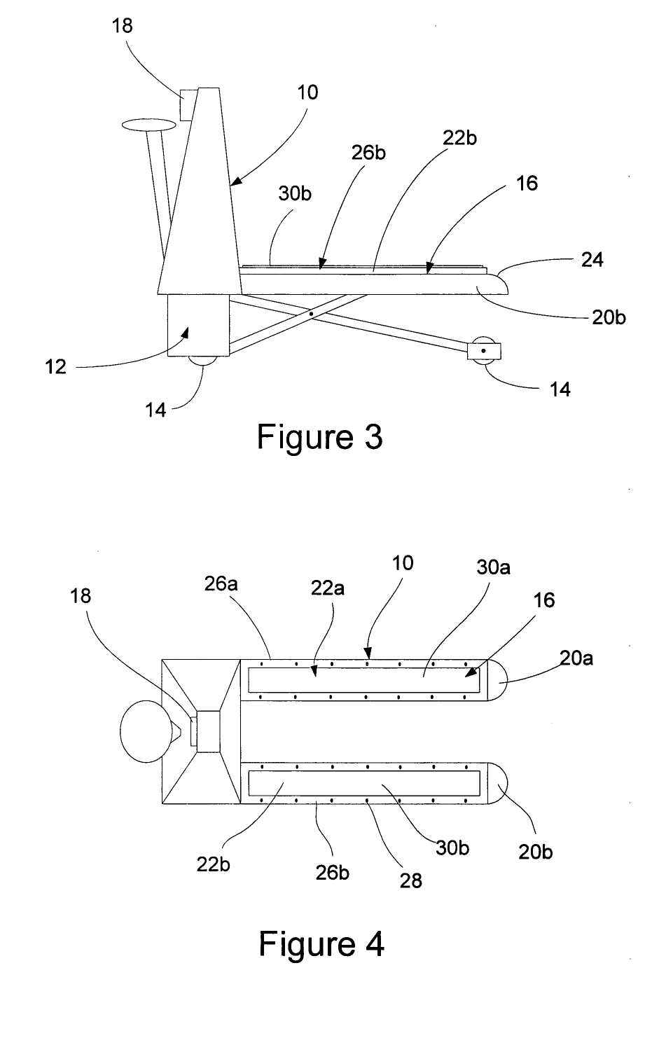

Alternatively, the vehicle 10 is the fork lift shown in FIGS. 3 and 4. The vehicle 10 includes a chassis 12 having a plurality of wheels 14 for effecting movement of the vehicle 10 across a floor or ground surface. The vehicle 10 also includes weighing apparatus 16 for bearing weight of the item and generating data representing the weight of the item. The vehicle 10 also includes indicator apparatus 18 for receiving the data representing the weight of the item and generating an indicator for the weight of the item. The indicator is data representing the weight for display on a visual display device (not shown). Alternatively, the indicator is data representing the weight for a printing device (not shown) that prints the weight on a docket.

The weighing apparatus 16 includes a load bearing platform 20 having two spaced apart parallel prongs 20a, 20b capable of supporting the weight of the item therebetween. The weighing apparatus 16 includes first and second scales 22a, 22b coupled to respective ones of the spaced apart parallel prongs 22a, 22b. The first and second scales 22a, 22b include stators 26a, 26b coupled to respective ones of the prongs 20a, 20b by fasteners 28, movable platforms 30a, 30b, and load cells (not shown) arranged between the stators 26a, 26b and the movable platforms 30a, 30b. The load cells generate said data representing weight of the item seated on the scales 22a, 22b bridging the gap between the prongs 20a 20b. The prongs 20a, 20b are preferably shaped to slide into apertures in the base of a create, for example, so that the crate can be positioned over the scales 22a, 22b.

Preferred embodiments of the invention are hereafter described, by way of non-limiting example, with reference to the vehicle shown in FIGS. 3 and 4. however, the features of the invention are equally applicable to the vehicle shown in FIGS. 1 and 2, and any other vehicle falling within the scope of the invention.

As above mentioned, the chassis 12 include wheels 14 for effecting movement of the vehicle 10 across a floor or ground surface. The chassis 12 also includes driving apparatus 28 to effect substantially normal movement of the load bearing platform 20 with respect to the ground or floor surface. That is, the driving apparatus 28 is adapted to raise and lower the item with respect to the ground or floor surface. To the end, the vehicle 10 operates in an analogous manner to known forklifts that can drive across a floor or ground surface, and raise and lower items seated on the load bearing platform 20. The vehicle 10 can thereby be used to move items around a warehouse, for example, and also be used to load items onto shelves and trucks. The components of the vehicle 10 that perform these operations are generally known and are not described here in further detail.

The operation of the weighing apparatus and indicator apparatus are hereafter described by way of reference to the vehicle shown in FIGS. 3 and 4 by way of non-limiting example only. However, the description of the operation of these components is equally applicable to the vehicle shown in FIGS. 1 and 2.

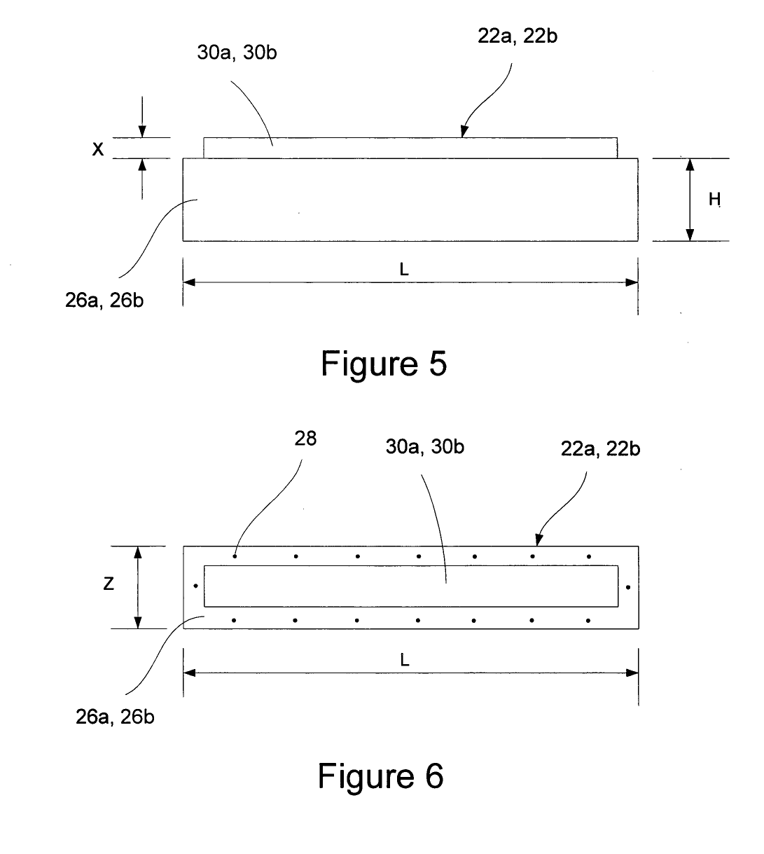

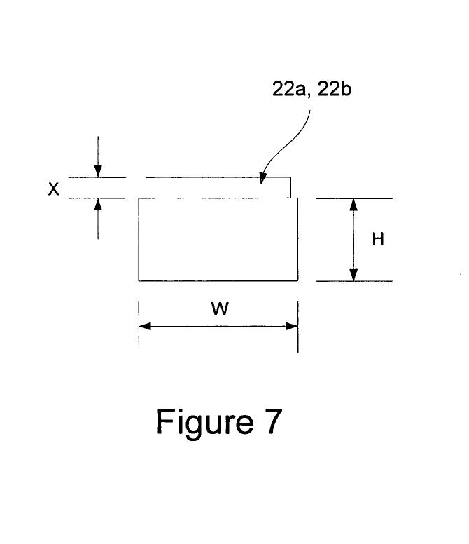

As particularly shown in FIGS. 5 to 7, the scales 22a, 22b are coupled to the prongs 20a, 20b of the load bearing platform 20 by fasteners 28. The fasteners a preferably crews counter sunk into the stators 26a, 26b. The stators 26a, 26b each have a length “L”, a height “H”, and a width “W”. The dimensions of each stator 26a, 26b are preferably:

| | | |
|---|---|---|
| a. | Length | 1020 mm; |
| b. | Height | 18 mm; and |
| c. | Width | 145 mm. |

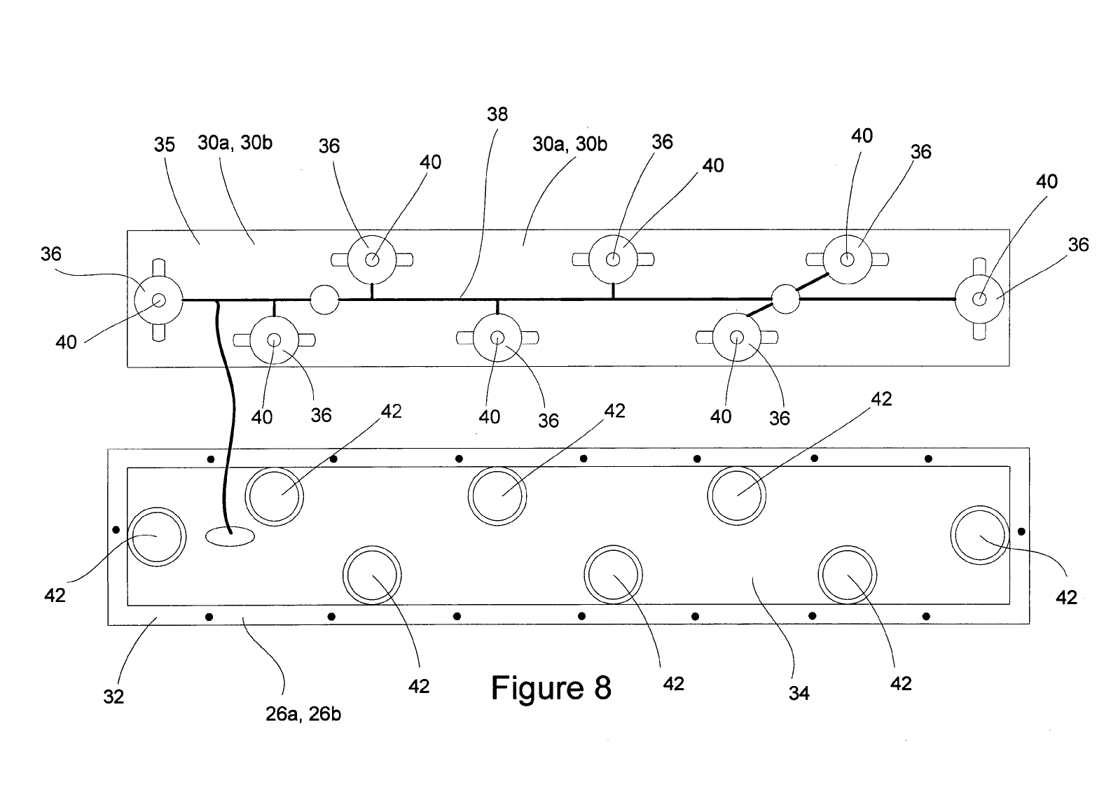

As particularly shown in FIG. 8, a top side 32 of each stator 26a, 26b includes a recess 34 that is shaped to at least partially receive a bottom side 35 the movable platform 30a, 30b. The bottom side 35 of the movable platform 30a, 30b is at least partially seated in the recess 34 when the scales 22a, 22b are assembled. The bottom side 35 of the movable platform 30a, 30b includes eight load cells 36 electrically interconnected by insulated conductors 38.

The recess 34 of each stator 26a, 26b includes eight plates 42 arranged to bear against load buttons 40 of the load cells 36 when the movable plate 30a, 30b is seated in the recess 34 in the manner shown in FIG. 5. The load buttons 40 resiliently recede into the load cells 36 when an item is placed on the scales 22a, 22b.

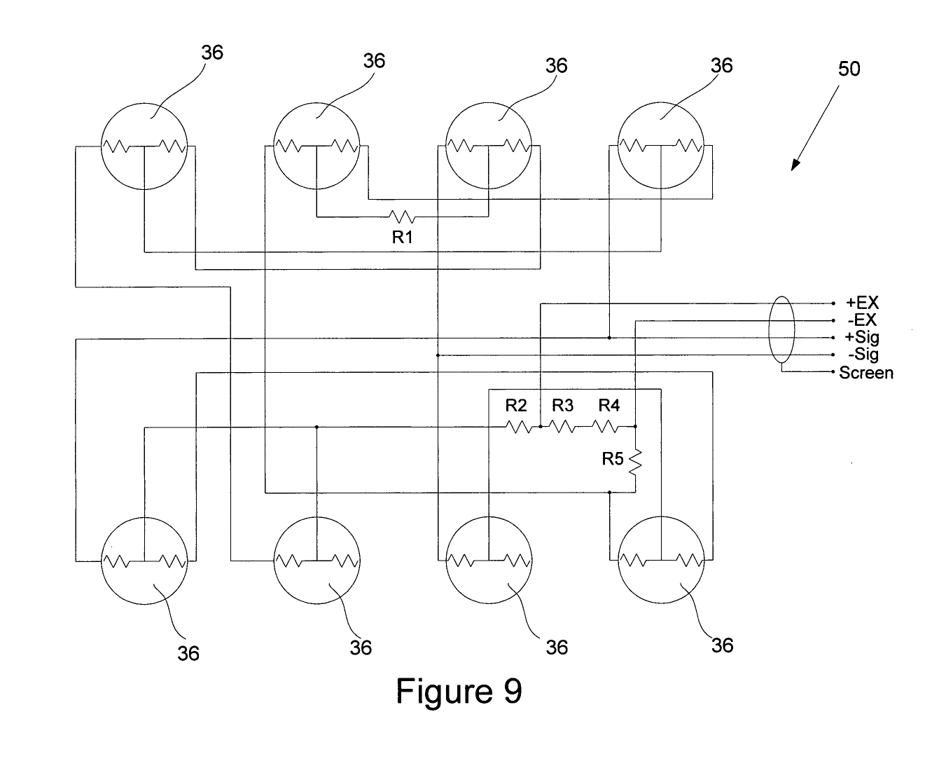

The load cells 36 in each scale 22a, 22b are electrically connected by an electric circuit 50 configured in the manner shown in FIG. 9. The circuit 50 include the following resistors:

| | | |
|---|---|---|
| a. | R1 | 0.6R |
| b. | R2 | 18R |
| c. | R3 | 3K6 |
| d. | R4 | 56K |
| e. | R5 | 15R |

The circuit 50 includes the following inputs/outputs:

| | |
|---|---|
| a. | +EX (RED); |
| b. | −EX (BLK); |
| c. | +SIG (GRN); |
| d. | −SIG (WHT); and |
| f. | SCREEN. |

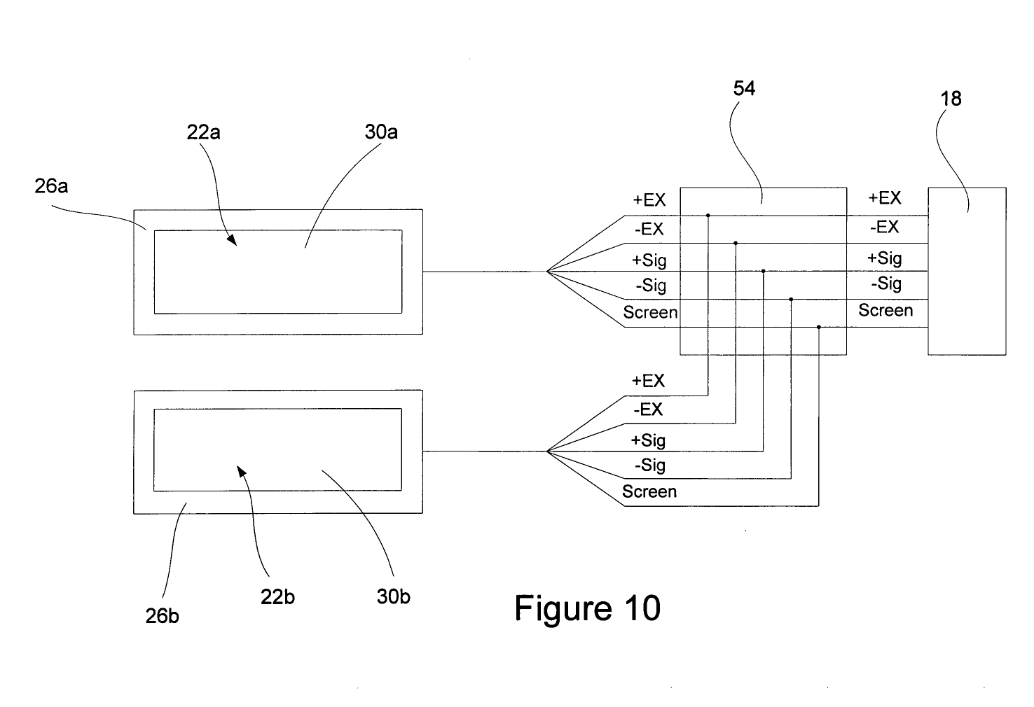

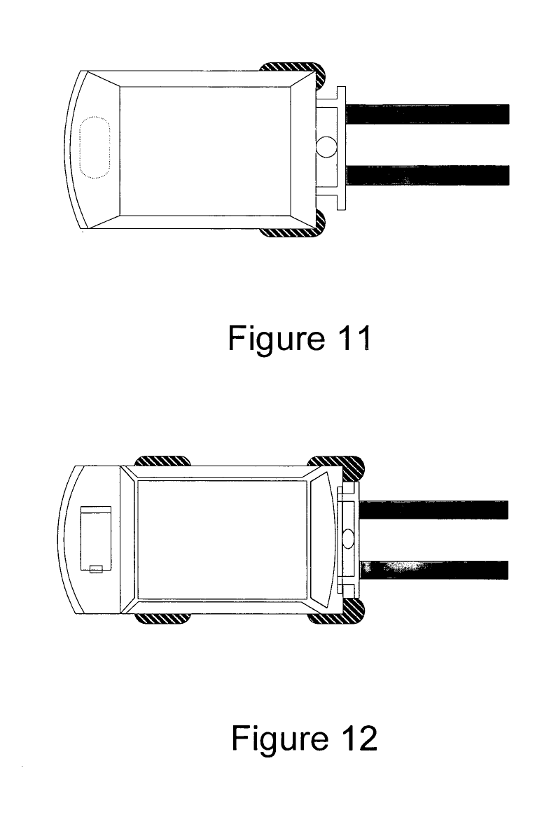

The scales 22a, 22b are electrically connected to the indicator apparatus 18, by way of the junction box 52, by the electric circuit 54 arranged in the manner shown in FIG. 10. The junction box 54 combines the output of corresponding conductors of the scales 22a and 22b, and passes the output to the indicator apparatus 18 which receives this data and generates an indicator for the weight of the item. The indicator is, for example, data representing the weight of the item for display on a visual display unit. Alternatively, the indicator is, for example, data representing the weight of the item for printing on a docket.

The indicator apparatus 18 preferably includes microcontroller (not shown) that performs a routine that involves the steps of:
a. Sending a 5V electric signal to the load cells 36 through the junction box 54;
b. Receiving analog return signals from the load cells 36;
c. Converting analog return signals into digital return signals; and
d. Displaying the digital return signals on a visual display device.

The microprocessor preferably effects a routine to perform the above-mentioned steps at a predetermined frequency

Variations in the return signals of the load cells occur when a force or physical load is placed on the scales 22a, 22b. When this occurs, the voltage of the return signals from the load cells 36 increases. The more force applied, the greater the voltage of the return signals.

The weight readings on the visual display device can be altered using a calibration function in the indicator apparatus 18. This is effected by way of scaling between raw millivolt input and the displayed reading.

A person can use the vehicle to weigh a crate of boxes, for example, by performing the following steps:
a. Driving the vehicle 10 so that the prongs 20a, 20b slide under the boxes and into corresponding apertures in the crate;
b. Engaging the driving apparatus of the chassis 12 so as to lift the crate off the ground or floor surface and its weight is borne by the weighing apparatus 16; and
c. Observing the weight displayed on the visual display unit of the indicator apparatus 18.

Preferred embodiments of the invention are described by of reference to load cells 36. However, any other suitable electronic weighing device could be alternatively used in the scales 22q, 22b.

Preferred embodiments of the invention are described by of reference to the vehicle 10 shown in FIGS. 1 to 4. However, vehicle could alternatively be any other suitable vehicle, such as the forklifts shown in FIGS. 11 and 12.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

1. A vehicle for weighing an item, including:
(a) a chassis having a plurality of wheels for effecting movement of the vehicle across a floor or ground surface;
(b) weighing apparatus for bearing weight of the item and generating data representing the weight of the item; and
(c) indicator apparatus for receiving said data representing the weight of the item and generating an indicator for the weight of the item.

2. The vehicle claimed in claim 1, wherein the weighing apparatus includes a load bearing platform capable of supporting the weight of the item.

3. The vehicle claimed in claim 2, wherein the weighing apparatus includes a scale having a stator coupled to the load bearing platform, a movable platform, and a plurality of load cells arranged between the stator and the movable platform.

4. The vehicle claimed in claim 3, wherein the load cells generate said data representing the weight of the item.

5. The vehicle claimed in claim 2, wherein the load bearing platform includes two spaced apart parallel prongs capable of supporting the weight of the item therebetween.

6. The vehicle claimed in claim 5, wherein the weighing apparatus includes first and second scales coupled to respective ones of the spaced apart parallel prongs.

7. The vehicle claimed in claim 6, wherein the first and second scales include stators coupled to respective ones of said prongs, weighing platforms, and load cells arranged between the stators and the weighing platforms.

8. The vehicle claimed in claim 7, wherein the load cells generate said data representing weight of the item.

9. The vehicle in claim 1, wherein the chassis includes driving apparatus to effect substantially normal movement of the load bearing platform with respect to the ground or floor surface.

10. The vehicle claimed in claim 9, wherein the driving apparatus is adapted to raise the item off the ground so that its weight is borne by the weighing apparatus.

11. The vehicle claimed in claim 1, wherein the load bearing platform is adapted to slide under the item.

12. The vehicle claimed in claim 1, wherein the indicator is data representing the weight for display on a visual display unit.

13. The vehicle claimed in claim 1, wherein the indicator is data representing the weight for printing on a docket.

14. The vehicle claimed in claim 1, wherein the vehicle is a forklift.

15. A weighing apparatus for a forklift, including:
(a) first and second scales couplable to respective ones of prongs of the forklift, said scales adapted to bear weight of an item therebetween and generate data representing the weight of the item; and
(b) indicator apparatus for receiving said data representing the weight of the item and generating an indicator for the weight of the item.

16. The apparatus claimed in claim 15, wherein the first and second scales include stators coupled to respective ones of said prongs, weighing platforms, and load cells arranged between the stators and the weighing platforms.

17. The apparatus claimed in claim 16, wherein the load cells generate said data representing weight of the item.

18. A method for weighing an item comprising:
(a) arranging the item on a weighing apparatus of a vehicle vehicle, wherein the vehicle comprises.
a chassis having a plurality of wheels for effecting movement of the vehicle across a floor or ground surface,
the weighing apparatus for bearing weight of the item and generating data representing the weight of the item, and
an indicator apparatus for receiving said data representing the weight of the item and generating an indicator for the weight of the item; and
(b) observing the indicator.

19. A method of weighing an item, comprising:
(a) arranging the item on a weighing apparatus of a vehicle under the item, wherein the vehicle comprises,
a chassis having a plurality of wheels for effecting movement of the vehicle across a floor or ground surface,
the weighing apparatus for bearing weight of the item and generating data representing the weight of the item,
wherein the chassis includes a driving apparatus to effect substantially normal movement of a load bearing platform of the weighing apparatus with respect to the around or a floor surface, and
an indicator apparatus for receiving said data representing the weight of the item and generating an indicator for the weight of the item;
(b) engaging the driving apparatus to effect substantially normal movement of the load bearing platform with respect to the ground or floor surface; and
(c) observing the indicator.

20. (canceled)

21. (canceled)

22. (canceled)
